(19) United States
(12) Patent Application Publication
(10) Pub. No.: US 2026/0171890 A1
(43) Pub. Date: Jun. 18, 2026

(54) FULL-WAVE RECTIFIER CIRCUIT AND POWER SUPPLY CIRCUIT

(71) Applicant: FUJI ELECTRIC CO., LTD., Kawasaki-shi (JP)

(72) Inventor: Ryuji YAMADA, Tokyo (JP)

(73) Assignee: FUJI ELECTRIC CO., LTD., Kawasaki-shi (JP)

(21) Appl. No.: 19/371,921

(22) Filed: Oct. 28, 2025

(30) Foreign Application Priority Data
Dec. 18, 2024 (JP) 2024-221819

(51) Int. Cl. H02M 1/00; H02M 1/14; H02M 1/42; H02M 7/219

(52) U.S. Cl. CPC H02M 1/0051; H02M 1/143; H02M 1/4233; H02M 7/219

(57) ABSTRACT

A full-wave rectifier circuit having a first input line and a second input line that are configured to receive an alternating current (AC) voltage, an output line configured to output a full-wave rectified voltage, and a ground line that is grounded. The full-wave rectifier circuit further includes : a first diode, having an anode connected to the first input line and a cathode connected to the output line; a second diode, having an anode connected to the ground line and a cathode connected to the first input line; a third diode, having an anode connected to the second input line and a cathode connected to the output line; a fourth diode, having an anode connected to the ground line and a cathode connected to the second input line; and first to fourth capacitors connected in parallel with the first to fourth diodes, respectively.

### CROSS-REFERENCE TO RELATED APPLICATIONS

The present application claims priority pursuant to 35 U.S.C. §119 from Japanese patent application number 2024-221819 filed on December 18, 2024, the entire disclosure of which is hereby incorporated by reference herein.

### BACKGROUND

### TECHNICAL FIELD

The present disclosure relates to a full-wave rectifier circuit and a power supply circuit.

### DESCRIPTION OF THE RELATED ART

For example, full-wave rectifier circuits include those each using four diodes to configure a diode bridge (for example, Japanese Patent Application Publication Nos.2008-079380, 2023-039047, 2014-150622).

Full-wave rectifier circuits are used in a power factor correction circuit, in order to generate a full-wave rectified voltage from an alternating current (AC) voltage. However, when the AC voltage has a low phase angle, the diodes of such a full-wave rectifier circuit are turned off, and thus an input current does not flow through the full-wave rectifier circuit, which may cause distortion of the input current.

### SUMMARY

An aspect of the present disclosure is a full-wave rectifier circuit that includes a first input line and a second input line that are configured to receive an alternating current (AC) voltage, an output line configured to output a full-wave rectified voltage, and a ground line that is grounded, the full-wave rectifier circuit comprising: a first diode having an anode connected to the first input line, and a cathode connected to the output line; a second diode having an anode connected to the ground line, and a cathode connected to the first input line; a third diode having an anode connected to the second input line, and a cathode connected to the output line; a fourth diode having an anode connected to the ground line, and a cathode connected to the second input line; and a first capacitor, a second capacitor, a third capacitor and a fourth capacitor connected in parallel with the first to fourth diodes, respectively.

Another aspect of the present disclosure is a power supply circuit configured to generate an output voltage at a target level from an alternating current (AC) voltage inputted thereto, the power supply circuit comprising: a full-wave rectifier circuit configured to receive the AC voltage, and output a full-wave rectified voltage; an inductor configured to receive the full-wave rectified voltage; a transistor configured to control an inductor current flowing through the inductor; a switching control circuit configured to control switching of the transistor, the full-wave rectifier circuit including a first input line and a second input line that are configured to receive the AC voltage, an output line configured to output the full-wave rectified voltage for power factor correction, and a ground line that is grounded, a first diode having an anode connected to the first input line, and a cathode connected to the output line, a second diode having an anode connected to the ground line, and a cathode connected to the first input line, a third diode having an anode connected to the second input line, and a cathode connected to the output line, a fourth diode having an anode connected to the ground line, and a cathode connected to the second input line; and a first capacitor, a second capacitor, a third capacitor and a fourth capacitor connected in parallel with the first to fourth diodes, respectively.

### BRIEF DESCRIPTION OF THE DRAWINGS

FIG. 1 is a diagram illustrating an example of a typical AC-DC converter 10.

FIG. 2 is a diagram illustrating a configuration example of a power factor correction IC 23.

FIG. 3 is a diagram illustrating an operation example of a power factor correction IC 23.

FIG. 4 is a diagram illustrating an operation example of a power factor correction IC 23.

FIG. 5 is a diagram illustrating a relationship among an input current Iin, an inductor current IL, and a discharge current Ic of a capacitor 21.

FIG. 6A is a diagram illustrating an example of a current flowing through a full-wave rectifier circuit 20a.

FIG. 6B is a diagram illustrating an example of a current flowing through a full-wave rectifier circuit 20a.

FIG. 6C is a diagram illustrating an example of a current flowing through a full-wave rectifier circuit 20a.

FIG. 6D is a diagram illustrating an example of a current flowing through a full-wave rectifier circuit 20a.

FIG. 7A is a diagram illustrating an example of a current flowing through a full-wave rectifier circuit 20a.

FIG. 7B is a diagram illustrating an example of a current flowing through a full-wave rectifier circuit 20a.

FIG. 7C is a diagram illustrating an example of a current flowing through a full-wave rectifier circuit 20a.

FIG. 7D is a diagram illustrating an example of a current flowing through a full-wave rectifier circuit 20a.

FIG. 8 is a diagram illustrating an example of an AC-DC converter 12.

FIG. 9 is a diagram illustrating a relationship among an input current Iin, an inductor current IL, and a discharge currents of capacitors C1 to C4.

FIG. 10A is a diagram illustrating an example of a current flowing through a full-wave rectifier circuit 20b.

FIG. 10B is a diagram illustrating an example of a current flowing through a full-wave rectifier circuit 20b.

FIG. 10C is a diagram illustrating an example of a current flowing through a full-wave rectifier circuit 20b.

FIG. 10D is a diagram illustrating an example of a current flowing through a full-wave rectifier circuit 20b.

FIG. 11A is a diagram illustrating an example of a current flowing through a full-wave rectifier circuit 20b.

FIG. 11B is a diagram illustrating an example of a current flowing through a full-wave rectifier circuit 20b.

FIG. 11C is a diagram illustrating an example of a current flowing through a full-wave rectifier circuit 20b.

FIG. 11D is a diagram illustrating an example of a current flowing through a full-wave rectifier circuit 20b.

FIG. 12 is a diagram illustrating capacitance values of capacitors C1 to C4.

### DETAILED DESCRIPTION

At least following matters will become apparent from the descriptions of the present description and the accompanying drawings. The same or equivalent constituent elements, members, and the like illustrated in the drawings are given the same reference numerals, and repetitive description is omitted as appropriate.

### Embodiment(s)

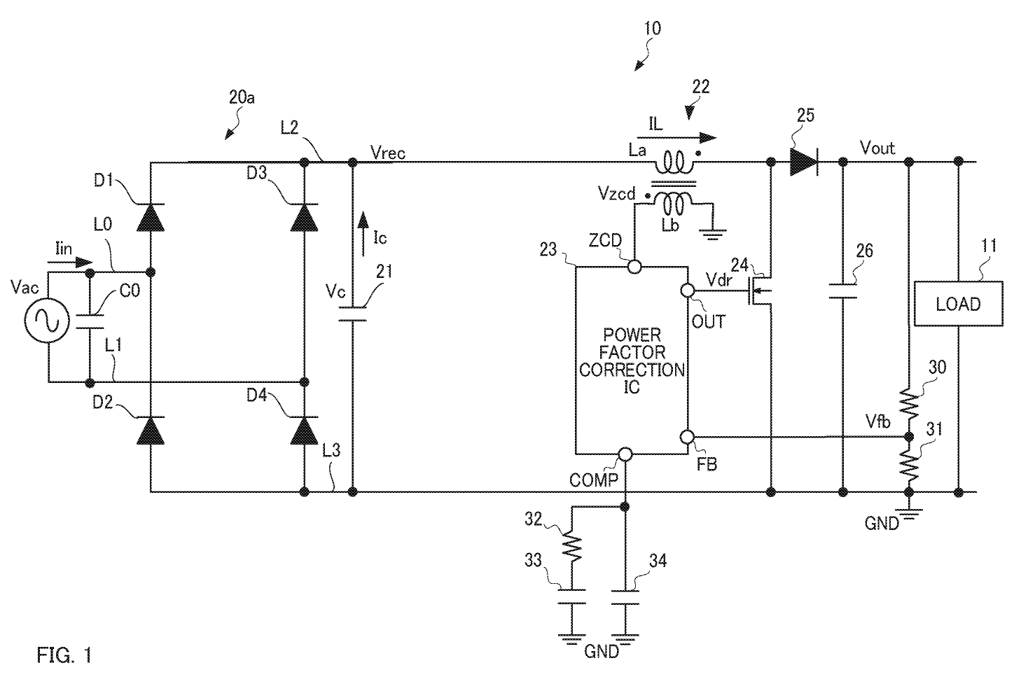

FIG. 1 is a diagram illustrating a configuration example of a typical AC-DC converter 10. The AC-DC converter 10 is a boos-chopper power supply circuit that generates an output voltage Vout at a target level from an alternating-current (AC) voltage Vac of a commercial power supply inputted thereto.

A load 11 is, for example, a DC-DC converter or an electronic device that operates on a direct-current (DC) voltage.

### Overview of typical AC-DC converter 10

The AC-DC converter 10 includes a full-wave rectifier circuit 20a, capacitors C0, 21, 26, 33, 34, a transformer 22, a power factor correction IC 23, an N-channel metal–oxide–semiconductor (NMOS) transistors 24, a diode 25, and resistors 30 to 32.

The capacitor C0 is provided between a first input line L0 and a second input line L1 so as to suppress the noise occurring in an input current Iin.

The full-wave rectifier circuit 20a full-wave rectifies the predetermined AC voltage Vac inputted from the first input line L0 and the second input line L1, and applies a full-wave rectified voltage Vrec, from an output line L2 to the capacitor 21 and a main coil La of the transformer 22. The full-wave rectifier circuit 20a has a ground line L3 as well. The AC voltage Vac herein is a voltage in a range of 100 to 240 V with a frequency in a range of 50 to 60 Hz, for example.

The full-wave rectified voltage Vrec is directly applied to the main coil La, however, for example, the full-wave rectified voltage Vrec may be applied thereto through an element such as a resistor (not illustrated).

The capacitor 21 is an element that absorbs the ripple component of an inductor current IL flowing through the main coil La, and prevents it from flowing to the power supply side, and the full-wave rectified voltage Vrec is applied across the main coil La upon turning on of the NMOS transistor 24. Meanwhile, upon turning off of the NMOS transistor 24, the main coil La supplies a current to the capacitor 26 through the diode 25. In addition to the above ripple current, a current flows through the capacitor 21 due to the full-wave rectified voltage Vrec being applied thereto. This corresponds to dVrec/dt, which is obtained by differentiating the full-wave rectified voltage Vrec by time, as the characteristics of the capacitor. As will be described in detail below, when the full-wave rectified voltage Vrec rises and dVrec/dt > 0 holds, the capacitor 21 is charged, and when the full-wave rectified voltage Vrec drops and dVrec/dt < 0 holds, the capacitor is discharged.

Further, the main coil La configures a boost chopper circuit together with the NMOS transistor 24, the diode 25, and the capacitor 26. Thus, the charge voltage of the capacitor 26 results in the direct-current (DC) output voltage Vout. Note that the output voltage Vout is 390 V, for example.

The transformer 22 includes the main coil La and an auxiliary coil Lb, which is magnetically connected to main coil La. Note that the auxiliary coil Lb in an embodiment of the present disclosure is formed by winding such that the voltage generated at the auxiliary coil Lb has a polarity opposite to that of the voltage generated at the main coil La. Then, a voltage Vzcd generated at the auxiliary coil Lb is applied to a terminal ZCD of the power factor correction IC 23.

The power factor correction IC 23 is an integrated circuit that controls switching of the NMOS transistor 24 such that the level of the output voltage Vout reaches a target level (for example, 390 V) while correcting the power factor of the AC-DC converter 10. Specifically, the power factor correction IC 23 drives the NMOS transistor 24, based on the inductor current IL flowing through the main coil La and the output voltage Vout.

The power factor correction IC 23 has terminals ZCD, FB, COMP, and OUT, and the power factor correction IC 23 will be described in detail below. Note that the power factor correction IC 23 also has terminals other than the above four terminals ZCD, FB, COMP, and OUT, but they are omitted here, for convenience.

The NMOS transistor 24 is a transistor to control power to the load 11 of the AC-DC converter 10. In an embodiment of the present disclosure, the NMOS transistor 24 is a Metal Oxide Semiconductor (MOS) transistor, but it is not limited thereto. As long as it is a transistor capable of controlling power, the NMOS transistor 24 may be a bipolar transistor, for example. The gate electrode of the NMOS transistor 24 is connected to the terminal OUT such that the NMOS transistor 24 is driven by a voltage Vdr from the terminal OUT.

The resistors 30 and 31 configure a voltage divider circuit that divides the output voltage Vout, to thereby generate a feedback voltage Vfb that is used in switching the NMOS transistor 24. The feedback voltage Vfb generated at the node at which the resistors 30 and 31 are connected is applied to the terminal FB.

The resistor 32 and the capacitors 33, 34 are elements for phase compensation for a stable operation of the AC-DC converter 10 including the power factor correction IC 23 that feedback-controls the NMOS transistor 24. The resistor 32 and the capacitor 33 are provided in series between the terminal COMP and the ground, and the capacitor 34 is provided in parallel with them.

### Configuration of Power Factor Correction IC 23

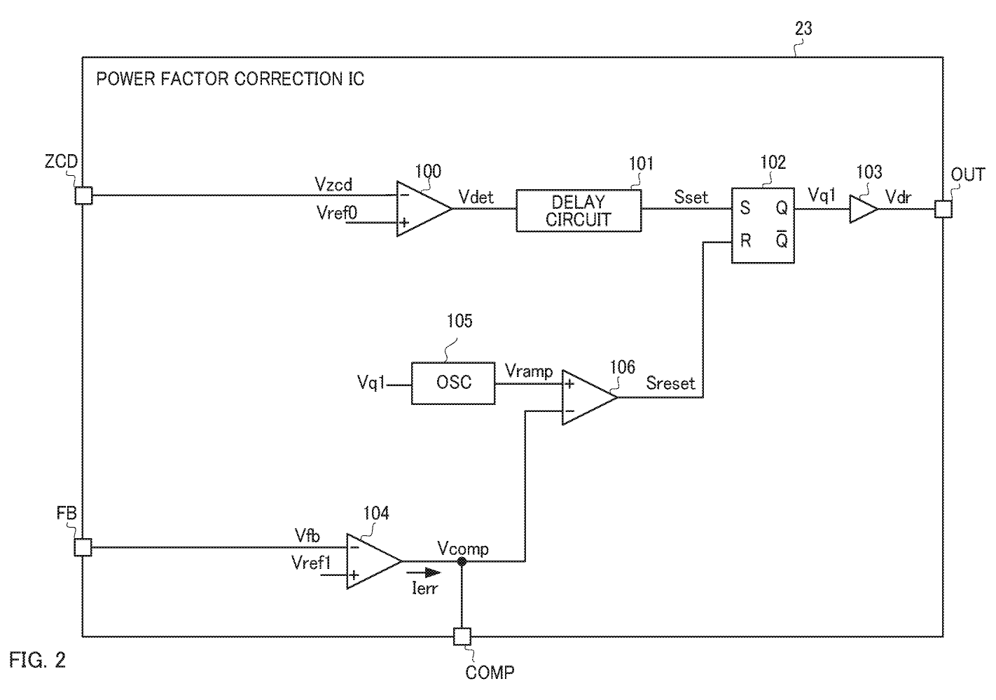

FIG. 2 is a diagram illustrating a configuration example of the power factor correction IC 23. The power factor correction IC 23 drives the NMOS transistor 24, based on the inductor current IL and the feedback voltage Vfb. The power factor correction IC 23 includes comparator circuits 100, 106, a delay circuit 101, an SR flip-flop 102, a buffer 103, an error voltage output circuit 104, and an oscillator circuit 105.

The comparator circuit 100 detects that the inductor current IL reaches zero, based on the voltage Vzcd at the terminal ZCD. Specifically, the comparator circuit 100 compares the voltage Vzcd with a reference voltage Vref0, and in response to the voltage Vzcd dropping below the reference voltage Vref0, outputs a signal Vdet at a high level (hereinafter, referred to as high or high level), assuming that the inductor current IL reaches zero. Meanwhile, in response to the voltage Vzcd exceeding the reference voltage Vref0, the comparator circuit 100 outputs the signal Vdet at a low level (hereinafter referred to as low or low level).

The delay circuit 101 outputs a pulse signal Sset to turn on the NMOS transistor 24 after a predetermined time period td has elapsed since the inductor current IL reaches zero. Specifically, the delay circuit 101 outputs the high pulse signal Sset after the predetermined time period td has elapsed since the rising edge of the signal Vdet from the comparator circuit 100. Meanwhile, the delay circuit 101 does not output the pulse signal Sset when the comparator circuit 100 outputs the low signal Vdet.

The SR flip-flop 102 outputs a driving signal Vq1 to switch the NMOS transistor 24. Specifically, in response to the delay circuit 101 outputting the high pulse signal Sset, the SR flip-flop 102 outputs the high driving signal Vq1 to turn on the NMOS transistor 24. Meanwhile, the SR flip-flop 102 outputs the low driving signal Vq1 to turn off the NMOS transistor 24, in response to the comparator circuit 106 (described later) outputting a high signal Sreset.

The buffer circuit 103 switches the NMOS transistor 24 in response to the driving signal Vq1. Specifically, the buffer 103 outputs the voltage Vdr to turn on the NMOS transistor 24, in response to the SR flip-flop 102 outputting the high signal Vq1. Meanwhile, the buffer 103 outputs the voltage Vdr to turn off the NMOS transistor 24, in response to the SR flip-flop 102 outputting the low signal Vq1.

The error voltage output circuit 104 generates an error current Ierr in accordance with an error between a reference voltage Vref1 corresponding to the output voltage Vout at the target level and the feedback voltage Vfb, charges the capacitors 33 and 34 through the terminal COMP, and generates a voltage Vcomp.

An oscillator circuit (OSC) 105 generates an oscillator voltage Vramp that is needed in turning off the NMOS transistor 24. Specifically, in response to the inductor current IL reaching zero and the high driving signal Vq1 being received, the oscillator circuit 105 outputs the oscillator voltage Vramp having an amplitude that gradually increases with a predetermined slope.

The comparator circuit 106 compares the voltage Vcomp and the oscillator voltage Vramp, in order to determine the timing at which the NMOS transistor 24 is turned off. Specifically, the voltage Vcomp is applied to the inverting input line of the comparator circuit 106, and the oscillator voltage Vramp is applied to the non-inverting input line of the comparator circuit 106. Thus, when the level of the oscillator voltage Vramp is lower than the level of the voltage Vcomp, the comparator circuit 106 outputs a low signal Sreset, and in response to the level of the oscillator voltage Vramp exceeding the level of the voltage Vcomp, the comparator circuit 106 outputs the high signal Sreset.

### Operation of power factor correction IC 23

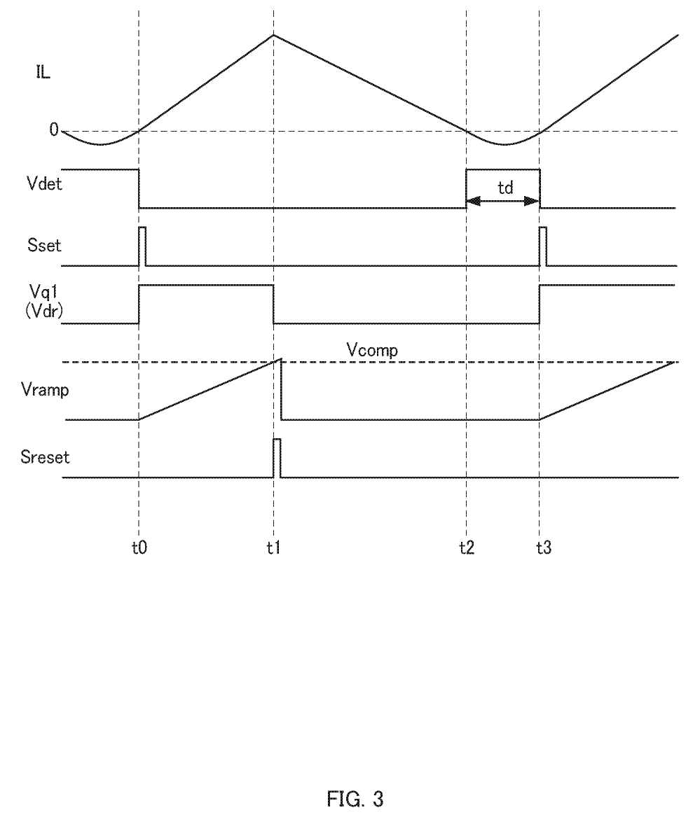

FIG. 3 is a diagram illustrating an operation example of the power factor correction IC 23.

At time t0, at which the power factor correction IC 23 outputs the voltage Vdr to turn on the NMOS transistor 24, the NMOS transistor 24 is turned on. Upon turning on of the NMOS transistor 24, the oscillator circuit 105 starts outputting the oscillator voltage Vramp with a predetermined slope.

At time t1, at which the oscillator voltage Vramp exceeds the voltage Vcomp, the comparator circuit 106 outputs the high signal Sreset. Then, the SR flip-flop 102 outputs the low signal Vq1, and the buffer 103 outputs the voltage Vdr to turn off the NMOS transistor 24.

At time t2, at which the inductor current IL reaches zero, the comparator circuit 100 outputs the high signal Vdet.

At time t3, at which the predetermined time period td has elapsed since time t2, the delay circuit 101 outputs the high pulse signal Sset. In response to the delay circuit 101 outputting the high pulse signal Sset, the SR flip-flop 102 outputs the high driving signal Vq1, and the buffer 103 outputs the voltage Vdr to turn on the NMOS transistor 24. Then, the NMOS transistor 24 is turned on. Hereinafter, the same or similar operation will be repeated.

Here, when the AC-DC converter 10 is generating the output voltage Vout at the target level from the predetermined AC voltage Vac, the capacitance of the capacitor 26 is sufficiently large and the feedback voltage Vfb is substantially constant within the time period corresponding to about one period of the AC voltage Vac.

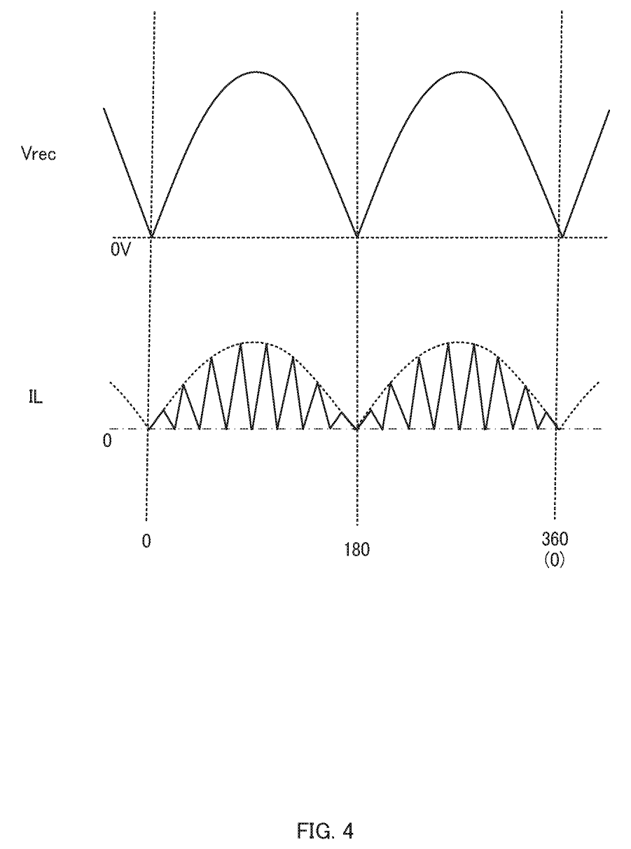

Further, in response to the rise in the level of the voltage Vrec obtained by rectifying the AC voltage Vac when the NMOS transistor 24 is ON, the current value of the inductor current IL increases. As a result, the waveform of the peak values of the inductor current IL results in being similar to that of the voltage Vrec, as illustrated in FIG. 4. Accordingly, the input current Iin is the average value of the inductor current IL, and thus has a waveform similar to that of the voltage Vrec, and the power factor of the AC-DC converter 10 approaches 1.

As the level of the peak value of the inductor current IL when the NMOS transistor 24 is turned off rises, the time period for the inductor current IL to reach zero when the NMOS transistor 24 is off increases. Accordingly, when the level of the voltage Vrec is low, the switching frequency of the NMOS transistor 24 rises, and when the level of voltage Vrec increases, the switching frequency of the NMOS transistor 24 decreases. In other words, in response to the AC voltage Vac having a low phase angle, the switching frequency of the NMOS transistor 24 increases, and in response to the AC voltage Vac having a high phase angle, the switching frequency of the NMOS transistor 24 decreases.

Note that the phase angle of the AC voltage Vac having the "high phase angle" refers to that the angle in the range of, for example, 90 ± 10 + 180n degrees, that is, in the range of (80 to 100) + 180n degrees. On the other hand, the "low phase angle" refers to that the angle in the range of, for example, 0 ± 10 + 180n degrees, that is, in the range of (-10 to +10) + 180n degrees. It is assumed here that n is an integer.

### Configuration of typical full-wave rectifier circuit 20a

As described above, in the full-wave rectifier circuit 20a, the AC voltage Vac is applied to the first input line L0 and the second input line L1, the AC voltage Vac is full-wave rectified, and the full-wave rectified voltage Vrec is outputted from the output line L2. Further, the ground line L3 of the full-wave rectifier circuit 20a is grounded. Here, the wording "ground" refers to being connected to the reference potential of the circuit, that is, GND, and does not necessarily refer to being connected to earth potential (earth). The same applies to the following description.

As illustrated in FIG. 1, the full-wave rectifier circuit 20a includes: the diode D1 having an anode connected to the first input line L0 and a cathode connected to the output line L2; the diode D2 having an anode connected to the ground line L3 and a cathode connected to the first input line L0; the diode D3 having an anode connected to the second input line L1 and a cathode connected to the output line L2; and the diode D4 having an anode connected to the ground line L3 and a cathode connected to the second input line L1. Note that the diodes D1 to D4 used in the full-wave rectifier circuit 20a are slow diodes that are to rectify a commercial frequency component.

### Operation of typical full-wave rectifier circuit 20a and capacitor 21

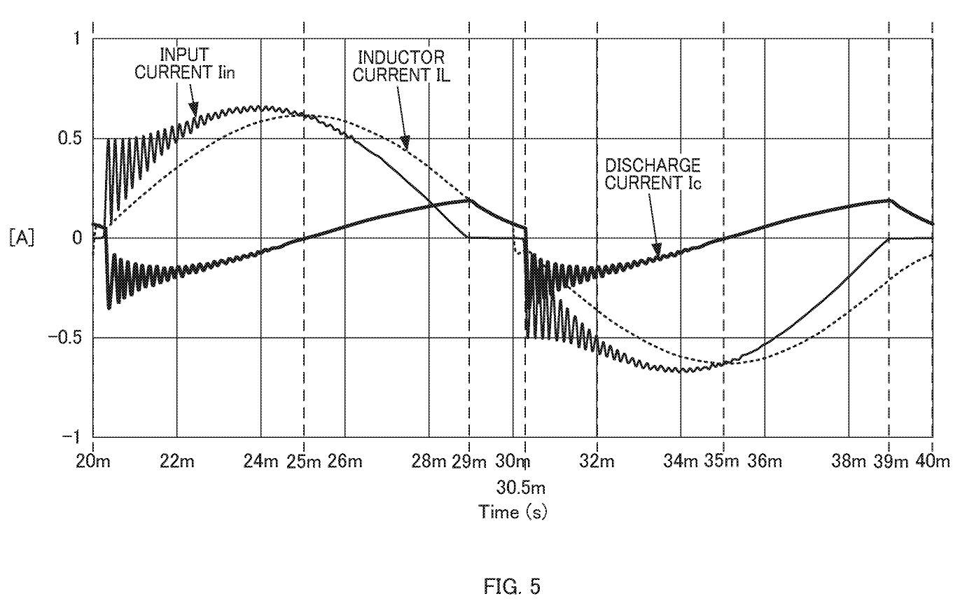

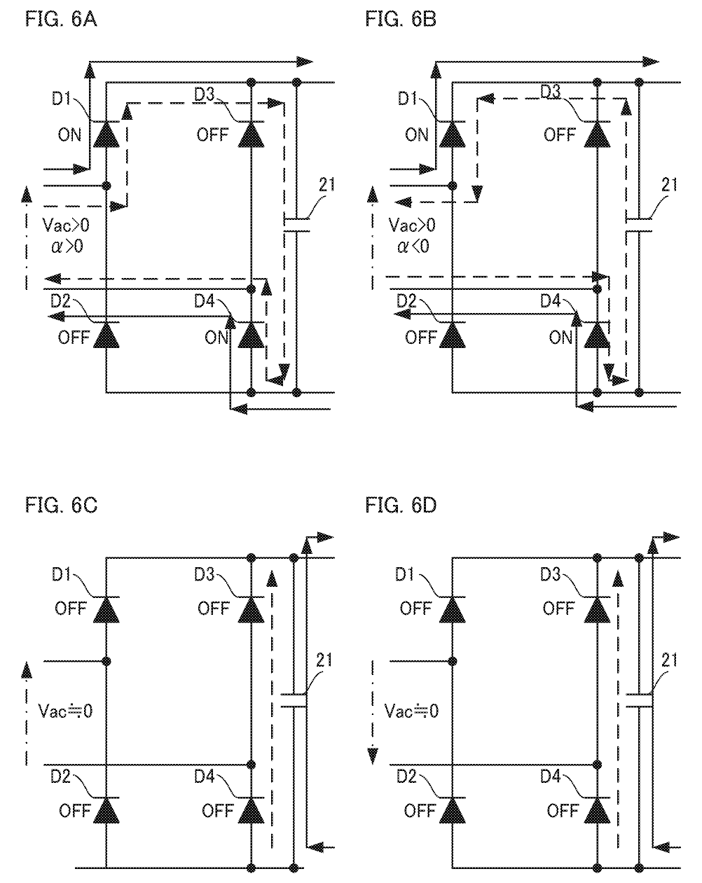

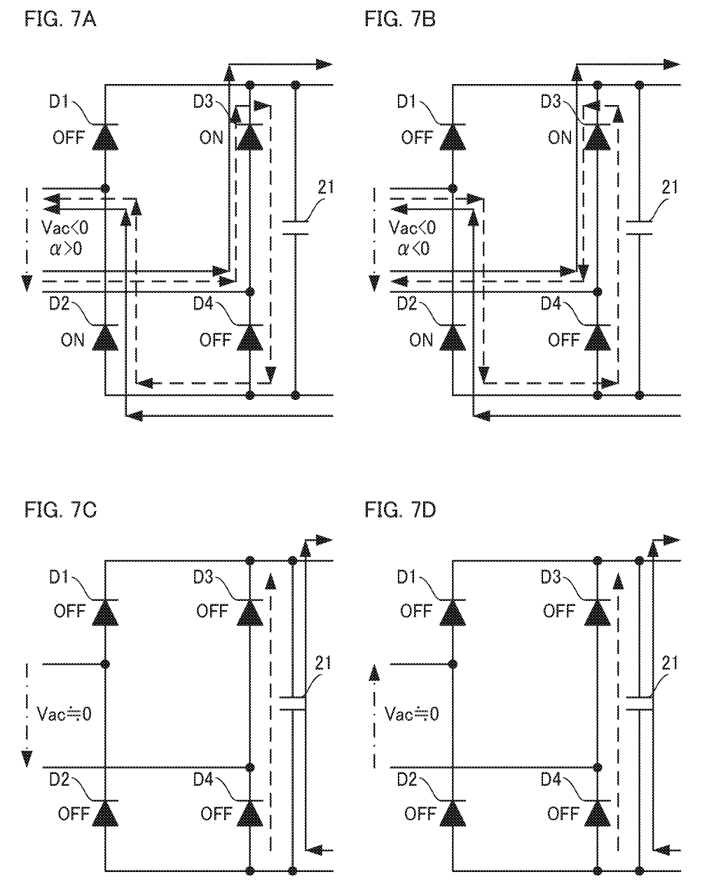

FIG. 5 is a diagram illustrating the relationship among the input current Iin, the inductor current IL, and the discharge current Ic of the capacitor 21. Note that a thin line indicates the input current Iin, a dotted line indicates the inductor current IL, and a thick solid line indicates the discharge current Ic of the capacitor 21. However, the actual waveform of the inductor current IL is the waveform on the triangular waves illustrated in FIG. 4, but illustrated here is the average value for each pulse period excluding the switching ripple current component. Furthermore, this waveform is a full-wave rectified waveform, which is similar to or the same as that of the voltage Vrec, but for comparison with the input current Iin, illustrated is the waveform obtained by determining the polarity according to the positive/negative polarity of the AC input voltage, that is, an equivalent waveform when seen from the input side of the AC voltage Vac. Hereinafter, the term "inductor current IL" refers to this equivalent waveform. The discharge current Ic similarly contains the switching component, but in the following description, the low-frequency component excluding the switching ripple will be referred to as discharge current Ic. Further, FIG. 5 illustrates the waveform corresponding to one period of the AC voltage Vac, and the discharge current Ic of the capacitor 21 assuming that it is positive when the current flows in the direction of discharge. Further, in FIGS. 6A to 6D and FIGS. 7A to 7D, the inductor current IL flowing through the main the coil La is given by a solid line, and the current Ic flowing through the capacitor 21 is given by a dashed line. Further, the arrow of the dashed-dotted line indicates whether the AC voltage Vac is positive or negative, and when the arrow points upward, the AC voltage Vac is a positive voltage, and when the arrow points downward, the AC voltage Vac is a negative voltage. Furthermore, α represents dVrec/dt.

In the time period from time 20 milliseconds to time 25 milliseconds, when the AC voltage Vac increases as a positive voltage, α > 0 holds. In response to the AC voltage Vac exceeding the charge voltage Vc of the capacitor 21, the diode D1 is turned on, and in association therewith, the diode D4 is also turned on, and the diode D3 is turned off due to a reverse voltage being applied, and in association therewith, the diode D2 is also turned off. Further, since α > 0, the capacitor 21 is charged, and the inductor current IL and the current Ic flow as illustrated in FIG. 6A. That is, the inductor current IL flows to the primary coil La through the diode D1 that is ON and returns to the commercial power supply through the diode D4 that is ON. Further, the capacitor 21 is charged with the current Ic through the diode D1, and the current Ic returns to the commercial power supply through the diode D4. Accordingly, the input current Iin results in the current obtained by adding the inductor current IL and the current Ic. FIG. 5 illustrates assuming that the current Ic is positive when the current flows in the direction of discharge, and thus the current Ic in this case is negative, and the current value of the input current Iin results in the current value obtained by adding the current value of the inductor current IL and the absolute value of the current value of the current Ic. The ringing of the input current Iin and the current Ic between time 20 milliseconds and 22 milliseconds will be described below.

In the time period from time 25 milliseconds to time 29 milliseconds, when the AC voltage Vac decreases as a positive voltage, α < 0 holds. In this case, since the current value of the inductor current IL is larger than the current value of the current Ic, the diode D1 is ON, and in association therewith, the diode D4 is also ON, and the diode D3 is OFF due to a reverse voltage being applied, and in association therewith, the diode D2 is also OFF. Further, since α < 0, the capacitor 21 is discharged, and the inductor current IL and the current Ic flow as illustrated in FIG. 6B. That is, the inductor current IL flows to the primary coil La through the diode D1 that is ON and returns to the commercial power supply through the diode D4 that is ON. The current Ic also returns to the commercial power supply though the diode D1, and flows from the commercial power supply through the diode D4.

In the time period from time 29 milliseconds to time 30.5 milliseconds, when the AC voltage Vac > 0 holds but the AC voltage Vac is close to substantially zero volts, the inductor current IL decreases. Meanwhile, since the rate of change in the sine wave reaches the maximum when the value thereof reaches zero, the discharge current of the capacitor 21 increases and becomes equal to the inductor current IL at some point. Beyond this point, the inflow current from the diode bridge, in other words, “the inductor current IL - the discharge current Ic of the capacitor 21” will try to become negative, but the diodes will not allow the current of an opposite polarity to flow, and as a result, the charge voltage Vc of the capacitor 21 exceeds the AC voltage Vac. As illustrated in FIG. 6C, the diodes D1 to D4 are turned off, and thus the capacitor 21 is disconnected from the AC input. In this case, the inductor current IL is equal to the current Ic. After time 30 milliseconds, the positive and negative polarities of the AC voltage Vac change. Similarly, when the AC voltage Vac < 0 holds but the AC voltage Vac is close to substantially zero volts, the diodes D1 to D4 are off, as illustrated in FIG. 6D.

In the time period from time 30.5 milliseconds to time 32 milliseconds, when the AC voltage Vac increases as a negative voltage, α > 0 holds, and the absolute voltage level of the AC voltage Vac exceeds the voltage level of the charge voltage Vc of the capacitor 21, the diodes D2, D3 are turned on, and the capacitor 21 is charged, as illustrated in FIG. 7A. At this timing, in other words, when the AC voltage Vac increases from near zero volts as a negative voltage, α reaches substantially the maximum, and thus the current Ic flowing through the capacitor 21 reaches the maximum. Accordingly, the current Ic changes in a stepwise manner due to the diodes being electrically connected, and thus the inductance component of an AC power supply circuit (not illustrated) and the capacitors C0, 21 cause LC resonance, which causes ringing in the input current Iin. Similarly, in the time period from time 20 milliseconds to time 22 milliseconds as well, when the AC voltage Vac increases from near zero volts as a positive voltage, α reaches substantially the maximum, which causes ringing in the current Ic and the input current Iin.

Further, in the time period from time 30 milliseconds to time 35 milliseconds, when the AC voltage Vac increases as a negative voltage, α > 0 holds. In this case, the voltage level of the absolute value of the AC voltage Vac is higher than the voltage level of the charge voltage Vc of the capacitor 21, and thus the diode D3 is turned on, and in association therewith, D2 is turned on as well, and the diode D1 is turned off due to a reverse voltage being applied, and in association therewith, the diode D4 is turned off as well. Further, since α > 0 holds, the capacitor 21 is charged, and the inductor current IL and the current Ic flow as illustrated in FIG. 7A. That is, the inductor current IL flows to the primary coil La through the diode D3 that is ON and returns to the commercial power supply through the diode D2 that is ON. Further, the capacitor 21 is charged with the current Ic through the diode D3, and the current Ic returns to the commercial power supply through the diode D2. Accordingly, the input current Iin results in the current obtained by adding the inductor current IL and the current Ic. FIG. 5 illustrates, assuming that the current Ic is positive when the current flows through the capacitor 21 in the direction of discharge, and thus the current Ic in this case is negative, and the absolute value of the current value of the input current Iin results in the current value obtained by adding the absolute value of the current value of the inductor current IL and the absolute value of the current value of the current Ic.

In the time period from time 35 milliseconds to time 39 milliseconds, the AC voltage Vac decreases as a negative voltage, and α < 0 holds. In this case, the current value of the inductor current IL is larger than the current value of the current Ic, and thus the diode D3 is on, and in association therewith the diode is D2 on, and the diode D1 is off due to a reverse voltage being applied, and in association therewith, the diode D4 is off as well. Further, since α < 0 holds, the capacitor 21 is discharged, and the inductor current IL and the current Ic flow as illustrated in FIG. 7B. That is, the inductor current IL flows to the primary coil La through the diode D3 that is ON ,and returns to the commercial power supply through the diode D2 that is ON. Further, the current Ic returns to the commercial power supply through the diode D3, and flows from the commercial power supply through the diode D2.

In the time period from time 39 milliseconds to time 40 milliseconds, the positive and negative polarities of the AC voltage Vac change. When the AC voltage Vac < 0 holds but the AC voltage Vac is close to substantially zero volts, the charge voltage Vc of the capacitor 21 exceeds the AC voltage Vac, and the diodes D1 to D4 are turned off, as illustrated in FIG. 7C. In this case, the inductor current IL is equal to the current Ic, and the current no longer flows through the full-wave rectifier circuit 20a. Similarly, after 40 milliseconds, when the AC voltage Vac > 0 but is close to substantially zero volts, the diodes D1 to D4 are off, as illustrated in FIG. 7D.

Accordingly, in the typical full-wave rectifier circuit 20a, for example, with the diodes D1 to D4 being OFF from 29 milliseconds to 30 milliseconds, the input current Iin results in zero during that time period, causing distortion in the input current Iin and leading to a deterioration of the power factor.

### Overview of AC-DC converter 12

The AC-DC converter 12 includes a full-wave rectifier circuit 20b, the capacitors C0, 26, 33, 34, the transformer 22, the power factor correction IC 23, the NMOS transistor 24, the diode 25, and the resistors 30 to 32. Note that the main the coil La of the transformer 22 corresponds to an "inductor", and the power factor correction IC 23 corresponds to a "switching control circuit".

### Configuration of full-wave rectifier circuit 20b

In the full-wave rectifier circuit 20b, as in the full-wave rectifier circuit 20a, the AC voltage Vac is applied to the first input line L0 and the second input line L1, the AC voltage Vac is full-wave rectified, and the full-wave rectified voltage Vrec is outputted from the output line L2. Further, the ground line L3 of the full-wave rectifier circuit 20b is grounded.

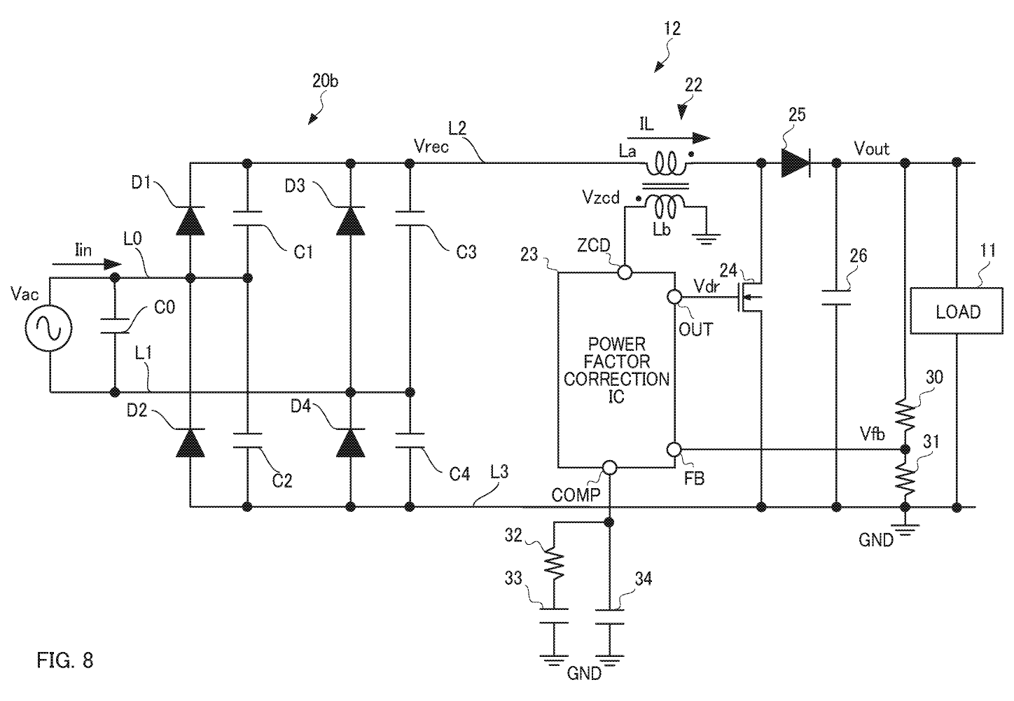

As illustrated in FIG. 8, the full-wave rectifier circuit 20b includes the diode D1 having an anode connected to the first input line L0 and a cathode connected to the output line L2, the diode D2 having an anode connected to the ground line L3 and a cathode connected to the first input line L0, the diode D3 having an anode connected to the second input line L1 and a cathode connected to the output line L2, the diode D4 having an anode connected to the ground line L3 and a cathode connected to the second input line L1, and capacitors C1 to C4 provided in parallel with the diodes D1 to D4, respectively. Note that the diodes D1 to D4 correspond to "first to fourth diodes", respectively, and the capacitors C1 to C4 correspond to "first to fourth capacitors", respectively.

### Operation of full-wave rectifier circuit 20b and capacitors C1 to C4

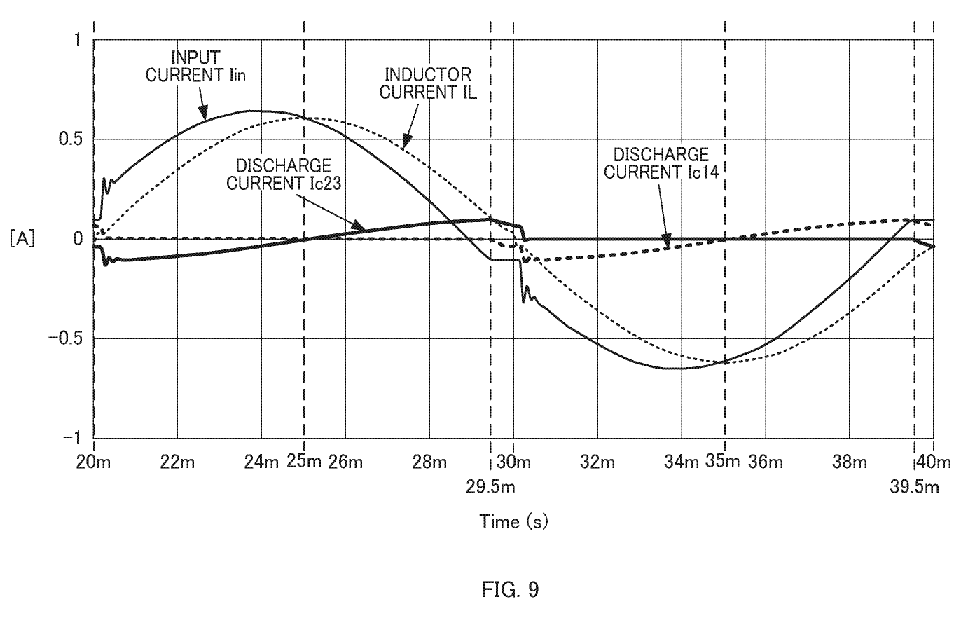

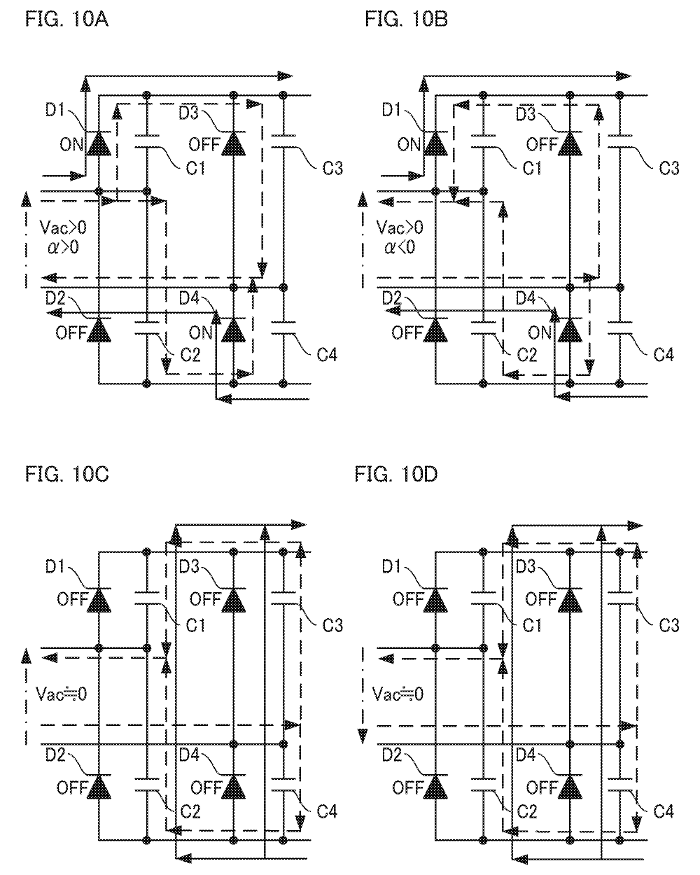

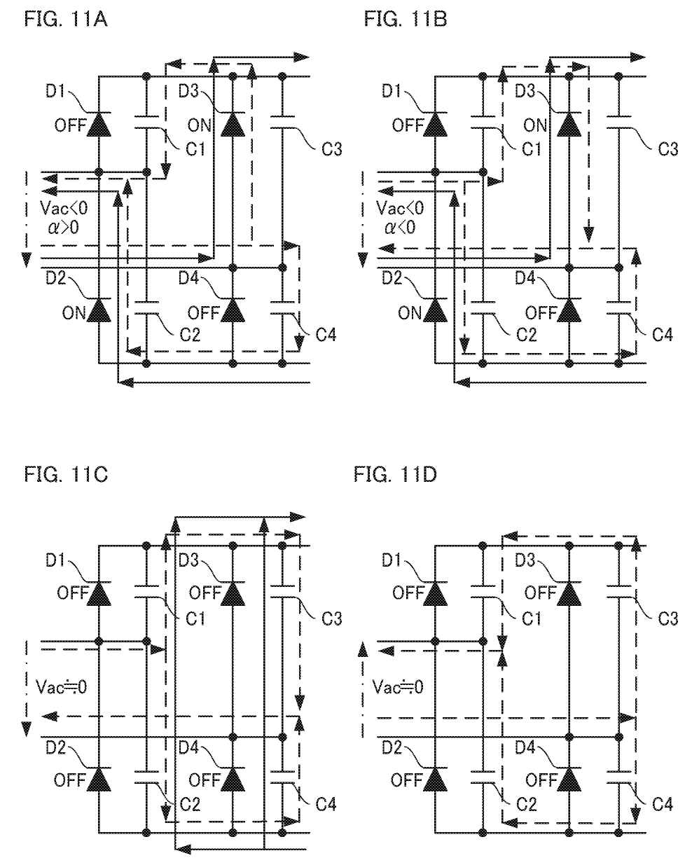

FIG. 9 is a diagram illustrating the relationship among the input current Iin, the inductor current IL, a discharge current Ic23 of the capacitors C2, C3, and a discharge current Ic14 of the capacitors C1, C4. Note that a thin line indicates the input current Iin, a thin dotted line indicates the inductor current IL, a thick solid line indicates the discharge current Ic23 of the capacitors C2, C3, and a thick dotted line indicates the discharge current Ic14 of the capacitors C1, C4. Further, FIG. 9 illustrates the waveforms corresponding to one period of the AC voltage Vac, and the discharge currents Ic23, Ic14 are drawn assuming that they are positive when the current flows in the direction of discharge. In FIGS. 10A to 10D and FIGS. 11A to 11D, the inductor current IL flowing through the main coil La is given by a solid line, and the currents Ic23, Ic14 flowing through the capacitors C1 to C4 are given by a dashed line. As in the case of FIG. 5, the inductor current IL is obtained by removing the switching ripple component and determining the polarity according to the polarity of the voltage of the AC power supply. Further, the discharge currents Ic23, Ic14 are also obtained by removing the switching ripple. Further, the arrow of the dashed-dotted line indicates whether the AC voltage Vac is positive or negative, and when the arrow points upward, the AC voltage Vac is a positive voltage, and when the arrow points downward, the AC voltage Vac is a negative voltage. Further, α represents dVrec/dt. The current Ic23 is a current flowing through the capacitors C2, C3, and the current Ic14 is a current flowing through the capacitors C1, C4. Further, it is assumed that the charge voltages of the capacitors C1 to C4 are voltages Vc1, Vc2, Vc3, and Vc4, respectively.

In the time period from time 20 milliseconds to time 25 milliseconds, when the AC voltage Vac increases, as a positive voltage, α > 0 holds. In response to the AC voltage Vac exceeding the charge voltage Vc3 of the capacitor C3, the diode D1 is turned on, and in association therewith, the diode D4 is turned on as well, and the diode D2 is turned off due to a reverse voltage being applied, and in association therewith, the diode D3 is turned off as well. Further, since α > 0, the capacitors C2, C3 are charged, and the inductor current IL and the current Ic23 flow as illustrated in FIG. 10A. That is, the inductor current IL flows to the primary coil La through the diode D1 that is ON and returns to the commercial power supply through the diode D4 that is ON. Further, the capacitor C3 is charged with the current Ic23 through the diode D1, and the current Ic23 returns to the commercial power supply without passing through a diode. Further, the capacitor C2 is charged with the current Ic23 without passing through a diode, and the current Ic23 returns to the commercial power supply through the diode D4. Accordingly, the input current Iin results in the current obtained by adding the inductor current IL and the current Ic23. FIG. 9 illustrates, assuming that the current Ic23 is positive when the current flows through the capacitors C1 to C4 in the direction of discharge, and thus the current Ic23 in this case is negative, and the current value of the input current Iin results in the current value obtained by adding the current value of the inductor current IL and the absolute value of the current value of the current Ic23.

In the time period from time 25 milliseconds to time 29.5 milliseconds, when the AC voltage Vac decreases as a positive voltage, α < 0 holds. In this case, the current value of the inductor current IL is larger than the current value of current Ic23, and thus the diode D1 is on, and in association therewith, the diode D4 is on, and the diode D2 is off due to a reverse voltage being applied, and in association therewith, the diode D3 is off as well. Further, since α < 0 holds, the capacitors C2, C3 are discharged, and the inductor current IL and the current Ic23 flow as illustrated in FIG. 10B. That is, the inductor current IL flows to the primary coil La through the diode D1 that is ON, and returns to the commercial power supply through the diode D4 that is ON. Further, the current Ic23 flows from the commercial power supply without passing through a diode, and returns to the commercial power supply while discharging the capacitor C3 through the diode D1. Further, the current Ic23 flows from the commercial power supply through the diode D4, and returns to the commercial power supply without passing through a diode while discharging the capacitor C2.

In the time period from time 29.5 milliseconds to time 30 milliseconds, when the AC voltage Vac > 0 holds but the AC voltage Vac is close to substantially zero volts, the AC voltage Vac drops below the charge voltage Vc3 of the capacitor C3, and the diodes D1 to D4 are turned off. In this case, the AC voltage Vac is lower than the charge voltages Vc2, Vc3, and thus the capacitor C3 is discharged to the commercial power supply through the capacitor C1, as illustrated in FIG. 10C. Further, the capacitor C2 allows the current to flow through the capacitor C4 and is discharged to the commercial power supply. Further, the inductor current IL flows through the capacitors C1 to C4. As such, even though the diodes D1 to D4 are OFF, the current flows through the full-wave rectifier circuit 20b. After time 30 milliseconds, the positive and negative polarities of the AC voltage Vac change. Similarly, when the AC voltage Vac < 0 holds but the AC voltage Vac is close to substantially zero volts as well, the current flows through the full-wave rectifier circuit 20b as illustrated in FIG. 10D, even though the diodes D1 to D4 are OFF.

Further, in the time period from time 30 milliseconds to time 35 milliseconds, when the AC voltage Vac increases as a negative voltage, α > 0 holds. In this case, the AC voltage Vac is higher than the charge voltage Vc1 of the capacitor C1, and thus the diode D3 is turned on, and in association therewith, the diode D2 is turned on, and the diode D1 is off due to a reverse voltage being applied, and in association therewith, the diode D4 is off as well. Further, since α > 0, the capacitors C1, C4 are charged, and the inductor current IL and the current Ic14 flow as illustrated in FIG. 11A. That is, the inductor current IL flows to the primary coil La through the diode D3 that is ON, and returns to the commercial power supply through the diode D2 that is ON. Further, the capacitor C1 is charged with the current Ic14 through the diode D3, and the current Ic14 returns to the commercial power supply. Further, the capacitor C4 is charged with the current Ic14 without passing through a diode, and the current Ic14 returns to the commercial power supply through the diode D2. Accordingly, the input current Iin results in the current obtained by adding the inductor current IL and the current Ic14. FIG. 9 illustrates, assuming that the current Ic14 is positive when current flows through the capacitors C1, C4 in the direction of discharge, and thus the current Ic14 in this case is negative, and the current value of the input current Iin results in the current value obtained by adding the absolute value of the current value of the inductor current IL and the absolute value of the current value of the current Ic14.

In the time period from time 35 milliseconds to time 39.5 milliseconds, when the AC voltage Vac decreases as a negative voltage, α < 0 hold. In this case, the current value of the inductor current IL is larger than the current value of current Ic14, and thus the diode D3 is on, and in association therewith, the diode D2 is on, and the diode D1 is off due to a reverse voltage being applied, and in association therewith, the diode D4 is off as well. Further, since α < 0 holds, the capacitors C1, C4 are discharged, and the inductor current IL and the current Ic14 flow as illustrated in FIG. 11B. That is, the inductor current IL flows to the primary coil La through the diode D3 that is ON, and returns to the commercial power supply through the diode D2 that is ON. Further, the current Ic14 returns to the commercial power supply through the diode D3 while discharging the capacitor C1. Further, the current Ic14 flows from the commercial power supply through the diode D2, and returns to the commercial power supply while discharging the capacitor C4.

In the time period from time 39.5 milliseconds to time 40 milliseconds, when the AC voltage Vac < 0 holds but the AC voltage Vac is close to substantially zero volts, the AC voltage Vac drops below the charge voltage Vc4 of the capacitor C4, and the diodes D1 to D4 are turned off. In this case, the AC voltage Vac is lower than the charge voltage Vc4, and thus the capacitor C4 is discharged to the commercial power supply, as illustrated in FIG. 11C. Further, the capacitor C1 is discharged to the commercial power supply through the capacitor C3. Further, the inductor current IL flows through the capacitors C1 to C4. As such, even though the diodes D1 to D4 are OFF, the current flows through the full-wave rectifier circuit 20b. After the time 40 milliseconds, the positive and negative polarities of the AC voltage Vac change. Similarly, when the AC voltage Vac > 0 holds but the AC voltage Vac is close to substantially zero volts as well, the current flows through the full-wave rectifier circuit 20b as illustrated in FIG. 11D, even though the diodes D1 to D4 are off.

Accordingly, for example, in the time period from time 29.5 milliseconds to time 30 milliseconds, even if the diodes D1 to D4 are turned off, the input current Iin does not reach zero, and thus distortion in the input current Iin is less likely to occur, leading to improvement of the power factor. This makes it possible to provide the full-wave rectifier circuit that allows the input current to flow therethrough even when the AC voltage has a low phase angle.

### Capacitance values of capacitors C1 to C4

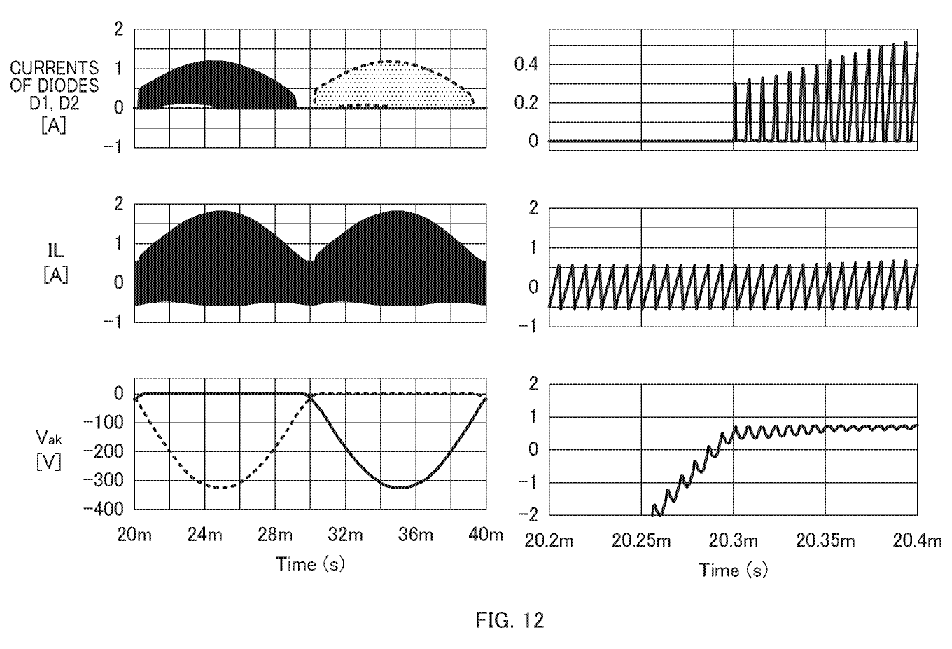

FIG. 12 is a diagram illustrating the capacitance values of the capacitors C1 to C4. FIG. 12 illustrates the simulation results of the current flowing through the diodes D1, D2, the inductor current IL, and a voltage Vak between the anode and the cathode of the diodes D1, D2. Note that the current flowing through the diode D1 is given by a solid line, and the current flowing through the diode D2 is given by a dashed line. Further, the voltage Vak at the diode D1 is given by a solid line, and the voltage Vak at the diode D2 is given by a dashed line. The following describes first focusing on the current flowing through the diodes D1, D2 and the voltage Vak at the diodes D1, D2. Further, the inductor current IL flows in all the time periods.

In the time period from time 20.3 milliseconds to 29 milliseconds, the diode D1 is on and the current flows through the diode D1. In this case, the diode D1 is on, and thus the voltage Vak at the diode D1 reaches near zero volts. On the other hand, a reverse voltage is applied to the diode D2, and the diode D2 is off, and thus the voltage Vak at the diode D2 results in a negative voltage corresponding to the AC voltage Vac. The voltage Vak at the diode D1, D2 is illustrated as the voltage at the anode with reference to the voltage at the cathode.

In the time period from time 29 milliseconds to 30 milliseconds, the diodes D1, D2 are off and the current does not flow through the diodes D1, D2. However, the inductor current IL flows through the capacitors C1 to C4. Further, around time 30 milliseconds, the AC voltage Vac changes from a positive voltage to a negative voltage, and since a reverse voltage is applied to the diode D1, the diode D1 is turned off, and since a forward voltage is applied to the diode D2, the diode D2 is turned on. Then, the current begins to flow through the diode D2.

In the time period from 30 milliseconds to 40 milliseconds, the current flows through the diode D2, and the voltage Vak at the diode D1 results in a negative voltage.

Next, the following describes focusing on the simulation results given on the lower right of FIG. 12, in which the voltage Vak of the diode D1 is enlarged to the time period from 20.2 milliseconds to 20.4 milliseconds. In the voltage Vak at the diode D1, a reverse voltage is applied to the diode D1 when it is OFF, and thus the diode D1 is turned off. In this case, with the capacitance values of the capacitors C1 to C4 being adjusted, even if a voltage indicating a ripple component caused by the switching frequency of the NMOS transistor 24 is generated at the capacitors C1 to C4 when the AC voltage Vac has a low phase angle, it will not change until it reaches the vicinity of the forward voltage. Accordingly, the diode D1 is not turned on due to the ripple component.

In contrast, in the time period from time 20.3 milliseconds at which the diode D1 is turned on, the ripple component is suppressed by the capacitors C1 to C4, and the ripple component does not cause the voltages generated at the capacitors C1 to C4 to be a negative voltage, and thus the diode D1 is not turned off. Further, as described above, the diodes D1 to D4 used in the full-wave rectifier circuit 20b are slow diodes that are directed to rectifying the commercial frequency components. Thus, repeatedly turning on and off the diodes D1 to D4 in a short period of time may result in excessive reverse recovery losses. However, with the ripple components being suppressed by the capacitors C1 to C4, repeatedly turning on and off of the diodes D1 to D4 is suppressed, thereby reducing the reverse recovery losses of the diodes D1 to D4.

As such, the capacitors C1 to C4 respectively have capacitance values such that the respective diodes D1 to D4 are not turned off due to the ripple component, when the respective diodes D1 to D4 are turned on based on the AC voltage Vac. This makes it possible to suppress repeatedly turning on and off of the diodes D1 to D4, thereby being able to suppress the reverse recovery losses of the diodes D1 to D4 when the AC voltage Vac has a low phase angle.

### Summary

A description has been given of the AC-DC converter 10 according to an embodiment of the present disclosure. The full-wave rectifier circuit 20b includes the diodes D1 to D4 and the capacitors C1 to C4 provided in parallel with the diodes D1 to D4, respectively. The full-wave rectifier circuit 20b allows the input current Iin to flow through the capacitors C1 to C4, even when the diodes D1 to D4 are OFF. This makes it possible to provide the full-wave rectifier circuit that allows the input current to flow therethrough even when the AC voltage has a low phase angle.

Further, the AC-DC converter 12 includes the full-wave rectifier circuit 20b, the main coil La, the NMOS transistor 24, and the power factor correction IC 23. This makes it possible to provide the full-wave rectifier circuit that allows the input current to flow therethrough even when the AC voltage has a low phase angle.

Further, the capacitors C1 to C4 respectively have the capacitance values such that the respective diodes D1 to D4 that are ON are not turned off due to the ripple component caused by the switching frequency of the NMOS transistor 24, when the respective first to fourth diodes D1 to 4 that are OFF are turned on. This makes it possible to suppress the ripple component of the voltage applied to the diodes D1 to D4, as with the capacitor 21 in the typical full-wave rectifier circuit 20a, thereby being able to suppress reverse recovery losses caused by turning on and off of the diodes D1 to d4 when the AC voltage Vac has a low phase angle.

The present disclosure is directed to provision of a full-wave rectifier circuit that allows an input current to flow therethrough even when the AC voltage has a low phase angle.

According to the present disclosure, it is possible to provide a full-wave rectifier circuit that allows an input current to flow therethrough even when the AC voltage has a low phase angle.

An embodiment of the present disclosure described above is simply to facilitate understanding of the present disclosure and is not in any way to be construed as limiting the present disclosure. The present disclosure may variously be changed or altered without departing from its essential features and encompass equivalents thereof.

What is claimed is:

1. A full-wave rectifier circuit that includes
a first input line and a second input line that are configured to receive an alternating current (AC) voltage,
an output line configured to output a full-wave rectified voltage, and
a ground line that is grounded,
the full-wave rectifier circuit comprising:
a first diode having
an anode connected to the first input line, and
a cathode connected to the output line;
a second diode having
an anode connected to the ground line, and
a cathode connected to the first input line;
a third diode having
an anode connected to the second input line, and
a cathode connected to the output line;
a fourth diode having
an anode connected to the ground line, and
a cathode connected to the second input line; and
a first capacitor, a second capacitor, a third capacitor and a fourth capacitor connected in parallel with the first to fourth diodes, respectively.

2. A power supply circuit configured to generate an output voltage at a target level from an alternating current (AC) voltage inputted thereto, the power supply circuit comprising:
a full-wave rectifier circuit configured to receive the AC voltage, and output a full-wave rectified voltage;
an inductor configured to receive the full-wave rectified voltage;
a transistor configured to control an inductor current flowing through the inductor;
a switching control circuit configured to control switching of the transistor,
the full-wave rectifier circuit including
a first input line and a second input line that are configured to receive the AC voltage,
an output line configured to output the full-wave rectified voltage for power factor correction, and
a ground line that is grounded,
a first diode having
an anode connected to the first input line, and
a cathode connected to the output line,
a second diode having
an anode connected to the ground line, and
a cathode connected to the first input line,
a third diode having
an anode connected to the second input line, and
a cathode connected to the output line,
a fourth diode having
an anode connected to the ground line, and
a cathode connected to the second input line; and
a first capacitor, a second capacitor, a third capacitor and a fourth capacitor connected in parallel with the first to fourth diodes, respectively.

3. The power supply circuit according to claim 2, wherein the first to fourth capacitors respectively have capacitance values such that the respective first to fourth diodes are not tuned off due to a ripple component caused by a switching frequency of the transistor, when the respective first to fourth diodes are turned on based on the AC voltage.
